(19) United States
(12) Patent Application Publication
(10) Pub. No.: US 2026/0273922 A1
(43) Pub. Date: Sep. 17, 2026

(54) Digital printing system and process

(71) Applicant: LANDA CORPORATION LTD., Rehovot (IL)

(72) Inventors: Gil Baran, Rehovot (IL); Yoav Geva, Moshav Tal Shahar (IL); Matan Bar-On, Hod Hasharon (IL); Roei Katalan, Ness Ziona (IL)

(21) Appl. No.: 18/873,759

(22) PCT Filed: Jun. 11, 2023
(86) PCT No.: PCT/IB2023/056011

§ 371 Date: Dec. 11, 2024

Related U.S. Application Data
(60) Provisional application No. 63/355,614, filed on Jun. 26, 2022.

(51) Int. Cl. B41J 2/01; B41J 3/60; B41J 13/00

(52) U.S. Cl. CPC B41J 2/01; B41J 3/60; B41J 13/0027; B41J 2002/012

(57) ABSTRACT

A method includes: (i) producing first image (43) on intermediate transfer member (ITM) (44), moving ITM along first direction (94) to engagement point between ITM and first substrate (50) for transferring the first image to the first substrate located at first position relative to the ITM, the first image transferred to given location on first substrate, and (ii) for second image (43a) intended to be produced on ITM after first image, and transferred to given location on second substrate (50): (a) second position relative to ITM, located at offset relative to first position, is specified for second substrate at engagement point, (b) second substrate moved at least in second direction (73a, 73b) to second position, and (c) second image produced on ITM at third position that would compensate for difference between the first and second positions, and the second image transferred to the given location on the second substrate.

### CROSS-REFERENCE TO RELATED APPLICATIONS

This application claims the benefit of U.S. Provisional Patent Application 63/355,614, filed Jun. 26, 2022, whose disclosure is incorporated herein by reference.

### FIELD OF THE INVENTION

The present invention relates generally to digital printing, and particularly to methods and systems for reducing a signature transferred between an intermediate transfer member and a substrate during a printing process.

### BACKGROUND OF THE INVENTION

Some printing systems have an intermediate transfer member, which is configured to receive an image and to transfer the image to a target substrate. In some cases, a print batch that contains a large number of copies (for example, thousands) of a particular image produced on the intermediate transfer member and transferred to a respective number of sheets, may cause undesired formation of an imprint of an edge of the sheet on the intermediate transfer member, so that the edge silhouette may appear in prints of another image, e.g., in the next print batch. This phenomenon may reduce the quality of subsequent images that are printed in subsequent batches using the same intermediate transfer member.

### SUMMARY OF THE INVENTION

An embodiment of the present invention that is described herein provides a method for printing, the method includes: (i) producing a first image on a movable intermediate transfer member (ITM) of a printing system, and moving the ITM along a first direction to an engagement point between the ITM and a first substrate for transferring the first image to the first substrate located at a first position relative to the ITM, the first image is transferred to a given location on the first substrate, and (ii) for a second image that is intended to be produced on the ITM after the first image and transferred to the given location on a second substrate: (a) a second position relative to the ITM, which is located at an offset relative to the first position, is specified for the second substrate at the engagement point, (b) the second substrate is moved at least in a second direction to the second position, and (c) the second image is produced on the ITM at a third position that would at least partially compensate for the difference between the first and second positions, and the second image transferred to the given location on the second substrate.

In some embodiments, the first and second substrates have an equal size, and the first and second images are copies of a given image. In other embodiments, the first and second substrates have a different size, and the first and second images are copies of a given image. In yet other embodiments, the second substrate is larger than the first substrate at least along an axis parallel to the second direction.

In some embodiments, the first and second directions differ from one another. In other embodiments, the first direction includes a printing direction, and the second direction includes a cross-printing direction. In yet other embodiments, the first and second substrates include first and second sheets, respectively, and moving the second sheet at least in the second direction includes controlling a sheet alignment assembly (SAA) to move the second sheet in the second direction to the second position, before the second sheet in being inserted into the engagement point.

In some embodiments, the first and second substrates include first and second sheets, respectively, which are piled in an input stack, and moving the second sheet at least in the second direction includes controlling an input pile centering assembly (PCA) to move the second sheet in the second direction: (i) after the first sheet is moved away from the input stack, and (ii) when the second sheet is located in the input stack. In other embodiments, the method includes controlling an output PCA to move an output stack in the second direction for receiving and piling the second sheet over the first sheet in the output stack. In yet other embodiments, producing the second image on the ITM at the third position includes controlling: (i) a motion assembly to move one or more print bars of the printing system in the second direction, and (ii) at least one or the print bars to apply droplets of printing fluid to predefined locations on a surface of the ITM.

There is additionally provided, in accordance with an embodiment of the present invention, a printing system including a printing assembly and a processor. The printing assembly is configured to produce an image on a movable intermediate transfer member (ITM), and to transfer the image to a substrate, the printing assembly includes one or more motion assemblies, configured to move: (i) the ITM, (ii) the printing assembly, and (iii) the substrate. The processor is configured to control the printing assembly to produce a first image on the ITM, and move the ITM along a first direction to an engagement point between the ITM and a first substrate for transferring the first image to the first substrate located at a first position relative to the ITM, the first image is transferred to a given location on the first substrate, and for a second image that is intended to be produced on the ITM after the first image, and transferred to the given location on a second substrate, the processor is configured to: (i) specify for the second substrate at the engagement point, a second position relative to the ITM, located at an offset relative to the first position, and (ii) control the printing assembly to: (a) move the second substrate at least in a second direction to the second position, (b) produce the second image on the ITM at a third position that would at least partially compensate for the difference between the first and second positions, and (c) transfer the second image to the given location on the second substrate.

There is further provided, in accordance with an embodiment of the present invention, a system including an interface and a processor. The interface is configured to receive a digital image intended to be printed, in a digital printing system, as first and second images on first and second substrates, respectively. The processor is configured to control a printing assembly to: (a) produce the first image on a movable intermediate transfer member (ITM), and (b) move the ITM along a first direction to an engagement point between the ITM and the first substrate for transferring the first image to the first substrate located at a first position relative to the ITM, the first image is transferred to a given location on the first substrate. For the second image that is intended to be: (a) produced on the ITM after the first image, and (b) transferred to the given location on the second substrate, the processor is configured to: (i) specify for the second substrate at the engagement point, a second position relative to the ITM, located at an offset relative to the first position, and (ii) control the printing assembly to: (a) move the second substrate at least in a second direction to the second position, (b) produce the second image on the ITM at a third position that would at least partially compensate for the difference between the first and second positions, and (c) transfer the second image to the given location on the second substrate.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIGS. 2A and 2B are schematic pictorial illustrations of imprints formed on a blanket of the digital printing system, in accordance with an embodiment of the present invention;

FIG. 3 is a schematic pictorial illustration of a sheet alignment assembly of the digital printing system, in accordance with an embodiment of the present invention; and

FIG. 4 is a flow chart that schematically illustrates a method for preventing the imprinting of previously printed images on the blanket of FIGS. 1 and 2, in accordance with an embodiment of the present invention.

### DETAILED DESCRIPTION OF EMBODIMENTS

### Overview

Digital printing on an industrial scale typically requires printing hundreds or thousands of copies of an image on hundreds or thousands of substrates, respectively. Some digital printing systems comprise a flexible intermediate transfer member (ITM) formed in a loop. The ITM is adapted to be moved and to receive ink droplets to form an image on the surface of the ITM. Subsequently, the moved ITM is engaged with a target substrate (e.g., a sheet) by applying an engagement (e.g., pressing) force, for transferring the image to the sheet. This process is repeated hundreds or thousands of times.

In some cases, the repeatable engagement force applied to one or more edges of the sheet may result in the undesired formation of imprints on the ITM (e.g., along a printing axis). Moreover, in some cases, the size of the sheet may be altered in a subsequent printing job. In such cases, a silhouette of the imprints may undesirably appear on the surface of the subsequent sheet, and thereby, may reduce the quality of the subsequent printed image. Therefore, it is important to reduce and even eliminate the formation of such imprints on the ITM.

Embodiments of the present invention that are described herein below provide improved techniques for reducing or preventing the formation of imprints on the ITM.

In some embodiments, a digital printing system comprises a printing assembly, and a processor. The printing assembly comprises (i) an image forming station configured to apply droplets of a printing fluid (e.g., multiple colors of ink), (ii) a movable intermediate transfer member (ITM) configured to receive the droplets for producing an image thereon, (iii) an impression station configured to engage between the ITM and a substrate (e.g., a sheet) for transferring the image to the sheet, and (iv) one or more motion assemblies, configured to move: (a) the ITM, (b) the printing assembly, and (c) the sheet.

In some embodiments, the droplets are directed by the image forming station to predefined locations on the surface of the moving ITM, so as to produce the image at a predefined location. Moreover, the image comprises multiple color image that are registered with one another so as to produce the image without distortions caused by relative displacement of the location of the droplets (i) between the color images, and (ii) within each of the color images.

In some embodiments, the processor is configured to control the printing assembly to produce a first image on the ITM, and to move the ITM along a first direction (e.g., a printing direction) to an engagement point between the ITM and a first sheet for transferring the first image to the first sheet located at a first position relative to the ITM, the first image is transferred to a given location on the first sheet.

In some embodiments, for a second image that is intended to be produced on the ITM after the first image and to be transferred to the given location on a second sheet, the processor is configured to specify for the second sheet at the engagement point, a second position relative to the ITM, which is located at an offset relative to the first position. The processor is further configured to control the printing assembly to: (i) move the second sheet at least in a second direction (e.g., a cross-printing direction, which is orthogonal to the printing direction) to the second position, (ii) produce the second image on the ITM at a third position that would at least partially compensate for the difference between the first and second positions, and (iii) transfer the second image to the given location on the second sheet. It is noted that altering the location of the sheets on the ITM at the engagement point, reduced or prevents the formation of the imprints on the ITM, and thereby, prevents the formation of silhouettes of the imprints on subsequent images printed on subsequent sheets, respectively.

### System Description

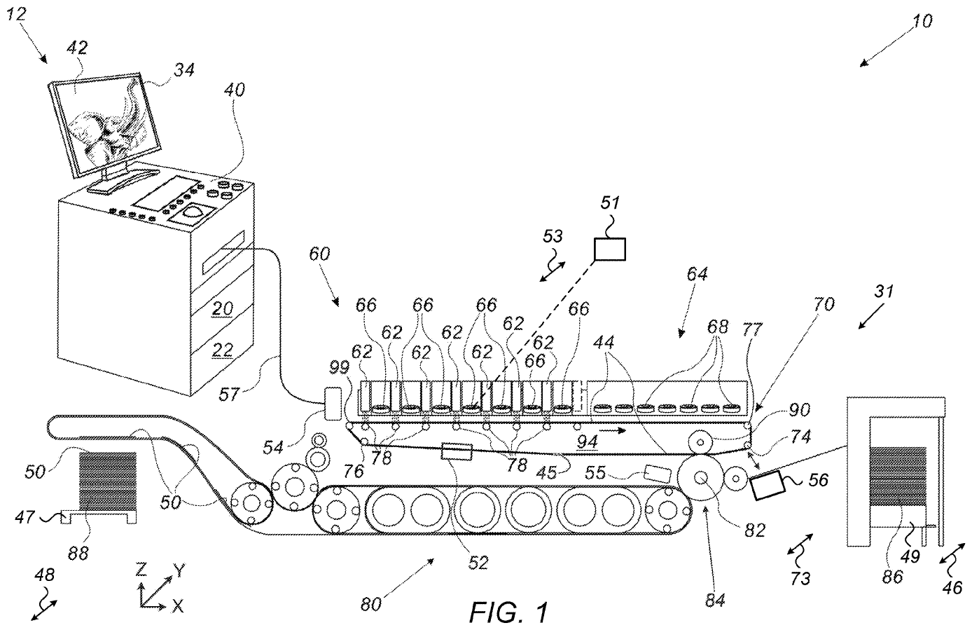

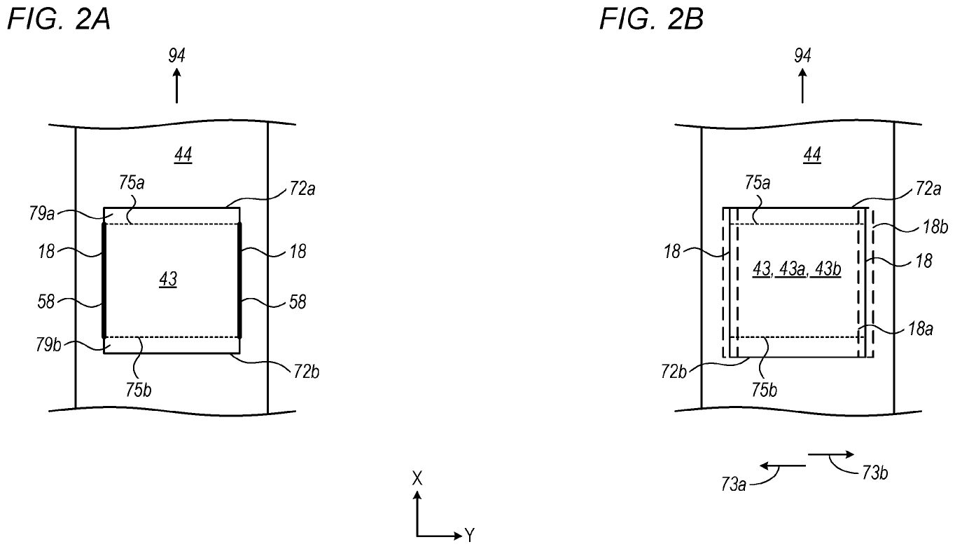

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate transfer member, which is formed in an endless loop configured to receive an ink image (shown in FIGS. 2A and 2B below), e.g., from image forming station 60, and to transfer the ink image to a target substrate, as will be described in detail below.

In an operative mode, image forming station 60 is configured to form a mirror ink image, also referred to herein as “an ink image” (shown in FIGS. 2A and 2B below) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black, and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” “color to color position difference,” “bar to bar registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 is guided over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

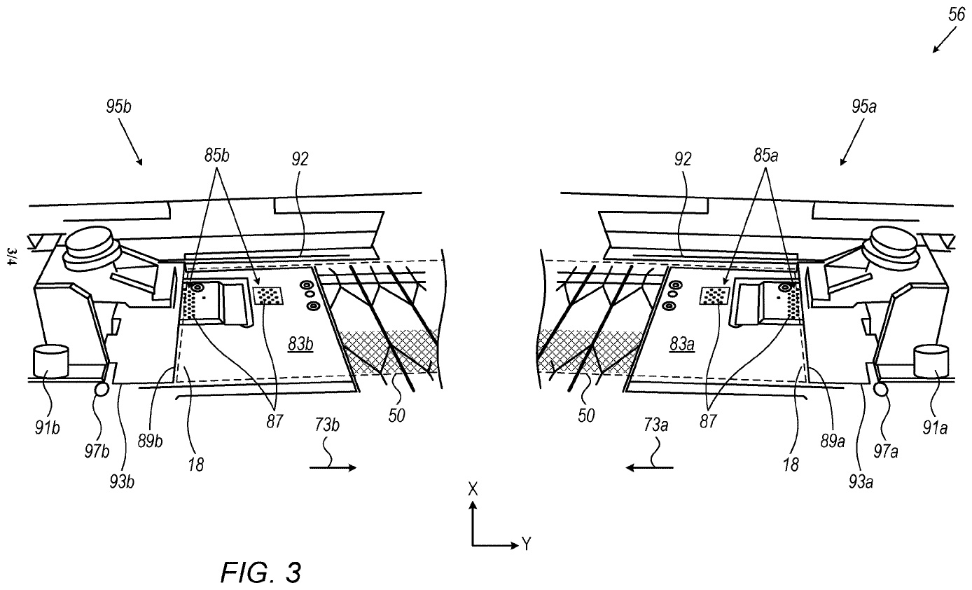

In impression station 84, blanket 44 passes between an impression cylinder 82 and a pressure cylinder 90, which is configured to carry a compressible blanket (shown in FIG. 3 below). In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic, or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single-and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In some embodiments, system 10 comprises a pile centering assembly (PCA) 49, which is configured to move input stack 86 of sheets 50 in a movement direction 46. Similarly, system 10 comprises a PCA 47, which is configured to move output stack 88 of sheets 50 in a movement direction 48. In the present example movement directions 46 and 48 are substantially parallel the Y-axis of the XYZ coordinate system, but in other embodiments, at least one of movement directions 46 and 48 may not be parallel to the Y-axis.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, system 10 comprises a motion assembly 51, which is configured to move one or more print bars 62 in a movement direction 53. In the present example, motion assembly 51 is configured to move all print bars 62 of image forming station 60 together.

In some embodiments, system 10 further comprises a sheet alignment assembly (SAA) 56, which is configured to move sheet 50 before being inserted into impression station 84. The structure and functionality of SAA 56 are described in detail in FIG. 3 below.

In some embodiments, movement directions 53 and 73 are substantially parallel the Y-axis of the XYZ coordinate system, but in other embodiments, at least one of movement directions 53 and 73 may not be parallel to the Y-axis. Note that in the present example, movement direction 53 differs from moving direction 94, which is the movement direction of blanket 44 and is also referred to herein as a printing direction (typically parallel to the X-axis of the XYZ coordinate system). More specifically for the present example, SAA 56 is configured to move sheet 50 in a cross-printing direction, which is typically approximately orthogonal to the printing direction (i.e., moving direction 94).

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises a printing assembly 31 that comprises: (i) image forming station 60, (ii) blanket 44, (iii) impression station 84, and (iv) and one or more motion assemblies, such as: (a) blanket module 70 configured to move blanket 44, (b) motion assembly 51 configured to move one or more of print bars 62 of image forming station 60, and (c) SAA 56 configured to move sheet 50 in the dross-print direction, before the sheet 50 being inserted into impression station 84, as described in detail above.

In some embodiments, printing assembly 31 may also comprise PCAs 49 and 47 configured to move input stack 86 and output stack 88, respectively, as described in detail above.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of thresholds, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Reducing Imprint of Sheet Edges on Blanket Surface

FIG. 2A is a schematic pictorial illustration of imprints 58 undesirably formed on blanket 44 while producing one or more ink images 43 on the surface of blanket 44, in accordance with an embodiment of the present invention. In the context of the present disclosure and in the claims, the terms ink image 43, image 43, and grammatical variations thereof, are used interchangeably.

In some cases, printing jobs may comprise printing thousands of images, which in the present example, are a copy of a given image (e.g., digital image 42 produced as ink image 43), on thousands of sheets 50, respectively. In other words, the same image is printing thousands of times on panels of blanket 44, and subsequently, are transferred from blanket 44 to thousands of sheets 50.

In some embodiments, impression cylinder 82 is periodically engaged with and disengaged from blanket 44, so that at the engagement position (also referred to herein as an engagement point) impression station 84 is configured to transfer the ink images 43 from moving blanket 44 to sheet 50 passing between blanket 44 and impression cylinder 82. In some embodiments, during the engagement, impression cylinder 82 and pressure cylinder 90 are pressed against one another between left and right edges 18 of sheet 50 (shown as imprints 58) and between dotted lines 75a and 75b of sheet 50. Note that the image 43 is transferred in the area defined between dotted lines 75a and 75b and between imprints 58, and not in sections 79a and 79b, which are considered as margins of sheet 50. Therefore, a smaller force is applied between impression cylinder 82 and pressure cylinder 90 in sections 79a and 79b compared to that applied to the area having image 43.

In some cases, the repeatable engagement force applied to left and right edges 18 of sheet 50 may result in the undesired formation of imprints 58 along the X-axis of blanket 44, whereas the smaller pressure applied between a leading edge 72a and a trailing edge 72b of sheet 50, does not form an imprint along the Y-axis of blanket 44.

In some case, the size of sheet 50 may alter in a subsequent printing job. For example, in the subsequent printing job the size of a subsequent sheet 50 along the Y-axis is larger than that of sheet 50 shown in FIG. 2A. In such cases, a silhouette of imprints 58 (and optionally of image 43) may undesirably appear on the surface of subsequent sheet 50, e.g., on the surface of the subsequent image 43 printed on the surface of the respective subsequent sheet 50. The silhouette of imprints 58 may reduce the quality of the subsequent image 43, and in severe cases, may result in trashing the respective subsequent sheets 50. Therefore, it is important to reduce and even eliminate the formation of imprints 58, and FIG. 2A below provides a pictorial illustration of a method for reducing imprints 58. Moreover, the difference between the sheet 50 and the subsequent sheet 50 may be in one or both X-axis and Y-axis, and the size ratio between the X-axis and the Y-axis may also differ between the sheet 50 and the subsequent sheet 50.

FIG. 2B is a schematic, pictorial illustration of a method for reducing or eliminating the formation of imprints 58 on the surface of blanket 44, in accordance with an embodiment of the present invention.

In some embodiments, before sheet 50 is being inserted into impression station 84, SAA 56 is configured to move the respective sheet 50 in a direction 73a or in a direction 73b. In the present example, both directions 73a and 73b are parallel to the Y-axis, but in other embodiments, at least one of directions 73a and 73b may have an orientation other than parallel to the Y-axis.

In an example implementation, a first batch of images 43 may be printed sequentially on a first batch of sheets 50 (e.g., having about 100 sheets 50), respectively, using the techniques described in detail in FIG. 1 above. In the example of FIG. 2B, the first batch is too small for forming imprints 58 on blanket 44. Edges 18 appear in a line thinner than the line of imprints 58 for illustrating that no imprints are formed on the surface of blanket 44.

Subsequently, a second batch of images 43a (which are similar to images 43, but are referred to herein as images 43a to illustrate that this is a different batch of copies of the same image 43) may be printed on a second subsequent batch of sheets 50 (e.g., having also about 100 sheets 50), respectively, using the same printing techniques with one difference described herein. In some embodiments, before being inserted into impression station 84, SAA 56 moves each sheet 50 of the second batch in direction 73a. Note that due to the movement in direction 73a, all sheets 50 of the second batch are engaged with blanket 44 at an offset relative to the location of the first batch of sheets 50. As shown in the example of Fug. 2B, the position of an edge 18a of sheet 50 of the second batch on blanket 44, has an offset relative to the position on blanket 44 of edge 18 of sheet 50 of the first batch.

Subsequently, a third batch of images 43b (which are similar to images 43, but are referred to herein as images 43b to illustrate that this is a different batch of copies of the same image 43) may be printed on a second subsequent batch of sheets 50 (e.g., having also about 100 sheets 50), respectively. In the example of FIG. 2B, sheets 50 of the third batch are moved by SAA 56 in direction 73b, so that an edge 18b is positioned on blanket 44 at a different position that that of edges 18 and 18a. In other words, moving one or more sheets 50 along the Y-axis (or in any other suitable direction), alters the location of edges 18, 18a and 18b, and reduces or eliminates the formation of imprints 58 on the surface of blanket 44.

FIG. 3 is a schematic pictorial illustration of a sheet alignment assembly (SAA) 56 of system 10, in accordance with an embodiment of the present invention.

In some embodiments, SAA 56 comprises one or more side lays configured to move sheet 50 in directions 73a and 73b as described above. In the example configuration shown in FIG. 3, sheet 50 is position on both side lays (SLs) 95a and 95b, so that SL 95a moves sheet 50 in direction 73a and SL 95b moves sheet 50 in direction 73b using techniques described herein.

In some embodiments, SL 95b comprises a substrate 83b, which is typically stationary, and a movable plate 93b which is configured to be moved in directions 73a and 73b, e.g., using a motor 91a controlled by controller 54 and/or processor 20. Similarly, SL 95a comprises a substrate 83b, which is typically stationary, and a movable plate 93a which is configured to be moved in directions 73a and 73b, e.g., using a motor 91b controlled by controller 54 and/or processor 20.

In some embodiments, when plates 93a and 93b are moved together in direction 73a, an edge 89a of plate 93a pushes edge 18 of sheet 50 in direction 73a, and at the same time, an edge 89b of plate 93b is moved in direction 73a in order to maintain the distance between edges 89a and 89b approximately equal to the size of sheet 50 along the Y-axis (e.g., the distance between edges 18 of sheet 50). Similarly, when plates 93a and 93b are moved together in direction 73b, edge 89b of plate 93b pushes sheet 50 in direction 73b, and at the same time, edge 89a of plate 93a is moved in direction 73b in order to maintain the distance between edges 89a and 89b approximately equal to the size of sheet 50 along the Y-axis.

In some embodiments, SAA comprises one or more sensors, such as sensors 97a and 97b, which are configured to produce signals indicative of the position of edges 89a and 89b, and/or the position of sheet 50, and processor 20 and/or controller 54 are configured to control the movement of sheet 50 in directions 73a and 73b based on the signals received from sensors 97a and 97b.

In some embodiments, substrate 89a comprises one or more arrays 85a of vacuum holes (VHs) 87 configured to attach sheet 50 to the surface of substrate 83a when vacuum is applied to VHs 87. Similarly, substrate 89b comprises one or more arrays 85b of vacuum holes (VHs) 87 configured to attach sheet 50 to the surface of substrate 83b when vacuum is applied to VHs 87.

In some embodiments, SAA 56 comprises one or more slits 92. In the present example, after being moved in direction 73a or 73b, system 10 is configured to move each sheet 50 through slit 92 into impression station 84 using any suitable technique.

In some embodiments, SAA 56 comprises a rail, which is configured to guide plates 93a and 93b being move in directions 73a and 73b. The rail may be implemented in slit 92 or using any other suitable structure configured to maintain the specified movement of plates 93a and 93b as described above.

Reference is now made to FIG. 1 above. In some embodiments, in response to moving a given sheet 50 in direction 73a or 73b as described above, processor 20 is configured to retain the image-to-substrate registration between the image and sheet 50.

In some embodiments, processor 20 is configured to control motion assembly 51 to move print bars 62 in direction 53 so that a first image (e.g., image 43 of FIGS. 2A and 2B above) is formed (after the movement of print bars 62) on a first panel of blanket 44 at an offset relative to a second previous image 43 of the same batch formed on a second previous panel of blanket 44 (before the movement of print bars 62).

In some embodiments, processor 20 is configured to control SAA 56 to move sheet 50 (which is intended to receive the first image 43) in direction 73 corresponding to the movement of print bars 62 in direction 53, so that the first image 43 is transferred to the intended location on the surface of the respective sheet 50 while retaining the same image-to-substrate registration between the first image 43 and the respective sheet 50.

Additionally, or alternatively, processor 20 is configured to move sheets 50 in direction 46 in order to prevent the undesired formation of imprints 58.

In some embodiments, the movements in at least one of directions 46, 73, 53 and 48 are typically between about 1 mm and 100 mm relative to a predefined default position of the respective entity. For example, SAA 56 is configured to move sheets 50 so that in the example of FIG. 2B, the distance between edges 18a and 18b is about 40 mm.

In alternative embodiments, the movement of sheets 50 may be used in conjunction with a sequential shifting of images 43 formed on blanket 44 in order to prevent the imprinting of the images 43 on blanket 44, also referred to herein as a memory effect, which is described in detail, for example, in PCT international application PCT/IB2022/054614, whose disclosure is incorporated herein by reference.

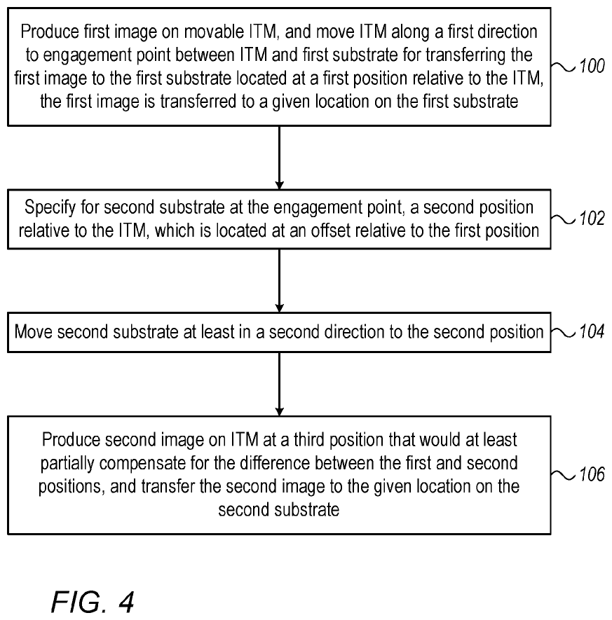

FIG. 4 is a flow chart that schematically illustrates a method for preventing the formation of imprint 58 of previously printed images 43 on blanket 44, in accordance with an embodiment of the present invention.

The method begins at a first image printing step 100, with processor 20 controlling stations and modules of system 10 (e.g., at least image forming station 60 and blanket module 70 described in detail in FIG. 1 above) to produce a first image 43 on blanket 44. It is noted that image 43 comprises an ink image of digital image 42. Moreover, processor 20 is configured to control blanket module 70 to move blanket 44 along direction 94 (parallel to the X-axis) to the engagement point (described in FIG. 1 above) between blanket 44 and a first sheet 50 for transferring the first image 43 to the first sheet 50 located at a first position relative to blanket 44. It is noted that the first image 43 is transferred to a given location on (the surface of) first sheet 50.

At a position specification step 102, for a second sheet 50 (also referred to herein as a second sheet 50a, which is similar to and subsequent to the first sheet 50), processor 20 is configured to specify, at the engagement point, a second position relative to blanket 44. In some embodiments, the second position is located at an offset, relative to the first position, at least along the cross-printing axis (e.g., the Y-axis of the XYZ coordinate system), as described in detail in FIG. 2B above.

At a substrate movement 104, processor 20 is configured control SAA 56 to move second sheet 50 at least in a second direction (e.g., direction 73a or direction 73b, which are typically but not necessarily parallel to the Y-axis) to the second position specified in step 102 above. An example configuration of SAA 56, and the operation of the movement of sheet 50 are described in detail in FIG. 3 above.

At a second image printing step 106 that concludes the method, processor 20 controls at least image forming station 60, motion assembly 51, and blanket module 70, to produce second image 43a on blanket 44. In some embodiments, processor 20 controls motion assembly 51 to move image forming station 60 (e.g., in direction 73a or 73b) so as to produce the second image 43a at a third position on blanket 44 that would at least partially (and typically fully) compensate for the difference between the first and second positions of the above steps 100 and 102, respectively. Moreover, in addition to controlling SAA 56 (as described in step 104 above), processor 20 controls impression station 84 to transfer the second image 43a to the given location on the second sheet 50, as described in detail in FIG. 2B above.

In other words, in order to prevent the formation of imprints 58 on blanket 44, processor 20 controls assembly 51 to move image forming station 60 in the cross-printing direction (e.g., direction 73 and/or 73b). And in order to maintain the required level of image-to-substrate registration, processor 20 controls assembly 56 to move sheets 50 in the same direction and distance, so to compensate for the movement performed by assembly 51.

Although the embodiments described herein mainly address digital printing using a flexible intermediate transfer member, the methods and systems described herein can also be used in other applications, such as in any sort of printing system and process having any suitable type of an intermediate apparatus (e.g., member) for receiving an image and transferring the image to a target substrate.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for printing, the method comprising:
producing a first image on a movable intermediate transfer member (ITM) of a printing system, and moving the ITM along a first direction to an engagement point between the ITM and a first substrate for transferring the first image to the first substrate located at a first position relative to the ITM, the first image is transferred to a given location on the first substrate; and
for a second image that is intended to be produced on the ITM after the first image and transferred to the given location on a second substrate:
specifying for the second substrate at the engagement point, a second position relative to the ITM, located at an offset relative to the first position;
moving the second substrate at least in a second direction to the second position; and
producing the second image on the ITM at a third position that would at least partially compensate for the difference between the first and second positions, and transferring the second image to the given location on the second substrate.

2. The method according to claim 1, wherein the first and second substrates have an equal size, and the first and second images are copies of a given image.

3. The method according to claim 1, wherein the first and second substrates have a different size, and the first and second images are copies of a given image.

4. The method according to claim 3, wherein the second substrate is larger than the first substrate at least along an axis parallel to the second direction.

5. The method according to claim 1, wherein the first and second directions differ from one another.

6. The method according to claim 5, wherein the first direction comprises a printing direction, and the second direction comprises a cross-printing direction.

7. The method according to claim 1, wherein the first and second substrates comprise first and second sheets, respectively, and wherein moving the second sheet at least in the second direction comprises controlling a sheet alignment assembly (SAA) to move the second sheet in the second direction to the second position, before the second sheet in being inserted into the engagement point.

8. The method according to claim 1, wherein the first and second substrates comprise first and second sheets, respectively, which are piled in an input stack, and wherein moving the second sheet at least in the second direction comprises controlling an input pile centering assembly (PCA) to move the second sheet in the second direction: (i) after the first sheet is moved away from the input stack, and (ii) when the second sheet is located in the input stack.

9. The method according to claim 8, and comprising controlling an output PCA to move an output stack in the second direction for receiving and piling the second sheet over the first sheet in the output stack.

10. The method according to claim 1, wherein producing the second image on the ITM at the third position comprises controlling: (i) a motion assembly to move one or more print bars of the printing system in the second direction, and (ii) at least one or the print bars to apply droplets of printing fluid to predefined locations on a surface of the ITM.

11. A printing system, comprising:
a printing assembly, which is configured to produce an image on a movable intermediate transfer member (ITM), and to transfer the image to a substrate, the printing assembly comprises one or more motion assemblies, configured to move: (i) the ITM, (ii) the printing assembly, and (iii) the substrate; and
a processor, which is configured to:
control the printing assembly to produce a first image on the ITM, and move the ITM along a first direction to an engagement point between the ITM and a first substrate for transferring the first image to the first substrate located at a first position relative to the ITM, the first image is transferred to a given location on the first substrate; and
for a second image that is intended to be produced on the ITM after the first image and transferred to the given location on a second substrate, (i) specify for the second substrate at the engagement point, a second position relative to the ITM, located at an offset relative to the first position, and (ii) control the printing assembly to: (a) move the second substrate at least in a second direction to the second position, (b) produce the second image on the ITM at a third position that would at least partially compensate for the difference between the first and second positions, and (c) transfer the second image to the given location on the second substrate.

12. The printing system according to claim 11, wherein the first and second substrates have an equal size, the first and second images are copies of a given image.

13. The printing system according to claim 11, wherein the first and second substrates have a different size, and the first and second images are copies of a given image.

14. The printing system according to claim 13, wherein the second substrate is larger than the first substrate at least along an axis parallel to the second direction.

15. The printing system according to claim 11, wherein the first and second directions differ from one another.

16. The printing system according to claim 15, wherein the first direction comprises a printing direction, and the second direction comprises a cross-printing direction.

17. The printing system according to claim 11, wherein the first and second substrates comprise first and second sheets, respectively, and comprising a sheet alignment assembly (SAA), which is configured to move the second sheet in the second direction to the second position, and wherein the processor is configured to control the SAA to move the second sheet at least in the second direction, before the second sheet in being inserted into the engagement point.

18. The printing system according to claim 11, wherein the first and second substrates comprise first and second sheets, respectively, which are piled in an input stack, and comprising an input pile centering assembly (PCA), which is configured to move the second sheet in the second direction, and wherein the processor is configured to control the input PCA to move the second sheet at least in the second direction: (i) after the first sheet is moved away from the input stack, and (ii) when the second sheet is located in the input stack.

19. The printing system according to claim 18, and comprising an output PCA, which is configured to receive and pile the first and second sheets in an output stack, and wherein the processor is configured to control the output PCA to move the output stack in the second direction for receiving and piling the second sheet over the first sheet in the output stack.

20. The printing system according to claim 11, and comprising: (a) multiple print bars, configured to apply droplets of printing fluid having multiple colors, respectively, and (b) a motion assembly, which is configured to move one or more of the print bars, and wherein the processor is configured to control: (i) the motion assembly to move one or more of the print bars in the second direction, and (ii) at least one or the print bars to apply droplets of the printing fluid to predefined locations on a surface of the ITM.

21. (canceled)
